(19) United States
(12) Patent Application Publication
(10) Pub. No.: US 2004/0152812 A1
(43) Pub. Date: Aug. 5, 2004

(54) Acrylic resin composition, adhesive comprising the composition, and optical laminate comprising the adhesive

(75) Inventors: Satoshi Yamamoto, Toyonaka-shi (JP); Tomo Iwata, Toyonaka-shi (JP); Yumiko Hashimoto, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/718,519

(22) Filed: Nov. 24, 2003

(30) Foreign Application Priority Data
Nov. 25, 2002 (JP) 2002-340534

(51) Int. Cl. C08K 5/24

(52) U.S. Cl. 524/261; 524/502; 525/163

(57) ABSTRACT

The present invention provides an acrylic resin composition comprising

an acrylic resin (1) and an acrylic resin (2),

wherein the acrylic resin (1) comprises

(i) a repeating unit derived from a methacrylate of the formula (A) (repeating unit (i))

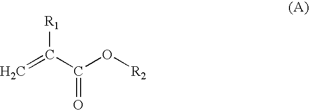

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds (repeating unit (ii)),

and wherein the acrylic resin (2) comprises repeating unit (i) and the acrylic

The present invention also provides an adhesive composition obtained by mixing the acrylic resin composition and at least one selected from the group consisting of a hardener and a silane-based compound; an optical laminate film comprising an optical film and the adhesive composition; and an optical laminate comprising an optical laminate film and a glass material layer.

### BACKGROUND OF THE INVENTION

1. Field of the Invention

The present invention relates to an acrylic resin composition, an adhesive composition containing the resin composition, an optical laminate film comprising the adhesive composition and an optical laminate comprising the optical laminate film.

2. Related Art

Liquid crystal cells generally used in liquid crystal displays such as TFT, STN and the like have a structure in which a liquid crystal component is sandwiched between two glass base materials. On the outer surface of this glass base material, optical films such as a polarizing film, phase retardation film and the like are laminated via an adhesive mainly composed of an acrylic resin.

An optical laminate sequentially laminating a glass substrate, adhesive and optical film is generally obtained by a method in which, first, an optical film with adhesive is produced by laminating an adhesive on an optical film, then, a glass base material is laminated on the surface of the adhesive.

Such an optical film with adhesive has a problem that it tends to be curled due to large change in dimension by elongation and shrinkage under heated condition or heated and humid condition, foaming occurs in an adhesive layer of the resulting optical laminate, peeling between the adhesive layer and glass base material is generated. Further, there is a problem that under heated condition or heated and humid condition, distribution of remaining stress acting on the optical film with adhesive becomes irregular, and stress concentrates on the periphery of the optical laminate, resultantly, light leakage is formed on a liquid crystal cell.

For solving such problems, JP2000-109771-A proposes the use, as an adhesive, of a resin composition composed of an acrylic resin having a weight-average molecular weight reduced by polystyrene of 600,000 to 2,000,000 and an acrylic resin having a weight-average molecular weight reduced by polystyrene of 500,000 or less. However, such resin compositions are not necessarily satisfactory in practical use in some cases.

### SUMMARY OF THE INVENTION

An object of the present invention is to provide an acrylic resin composition which can relax concentration of stress caused by elongation and shrinkage of an optical film, suppress light leakage of an optical laminate, suppress peeling between a glass material layer and an adhesive layer and foaming in an adhesive layer in an optical laminate, and which is suitable for an adhesive; an adhesive containing said acrylic resin composition; an optical laminate film composed of said adhesive layer and an optical film; and an optical laminate laminating glass substrate and the optical film via the adhesive layer of the optical laminate film.

The present inventors have intensively studied to solve such problems, and resultantly completed the present invention.

The present invention relates to the followings:

<1> An acrylic resin composition comprising an acrylic resin (1) and an acrylic resin (2),

wherein the acrylic resin (1) comprises

(i) a repeating unit derived from a methacrylate of the formula (A) (repeating unit (i))

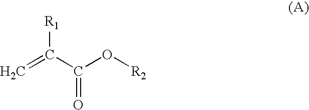

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds (repeating unit (ii)),

and wherein the acrylic resin (2) comprises repeating unit (i) and the acrylic resin (2) does not substantially have repeating unit (ii).

<2> The acrylic resin composition according to <1> wherein the content ratio of repeating unit (ii) in the acrylic resin (2) to repeating unit (ii) in the acrylic resin (1) is less than 1/10.

<3> The acrylic resin composition according to <1> or <2> wherein the content of repeating unit (i) in the acrylic resin (1) is 65 to 99.85 parts by weight per 100 parts by weight of the acrylic resin (1).

<4> The acrylic resin composition according to any of <1> to <3> wherein the content of repeating unit (ii) in the acrylic resin (1) is 0.05 to 5 parts by weight per 100 parts by weight of the acrylic resin (1).

<5> The acrylic resin composition according to any of <1> to <4> wherein at least one acrylic resin selected from the group consisting of the acrylic resin (1) and the acrylic resin (2) further comprises (iii) a repeating unit derived from a monomer containing at least one polar functional group selected from the group consisting of carboxyl, hydroxyl, amide, epoxy, formyl, oxetany, amino and isocyanate, and containing an olefinic double bond.

<6> The acrylic resin composition according to any of <1> to <5> wherein repeating unit (ii) is a repeating unit derived from a monomer comprising at least two (meth)acryloyl groups of the formula (B)

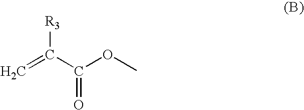

wherein R₃ represents hydrogen or methyl.

<7> The acrylic resin composition according to any of <1> to <6> wherein the content of the acrylic resin (1) is 10 to 60 parts by weight per 100 parts by weight of total the acrylic resin (1) and the acrylic resin (2).

<8> An adhesive composition obtained by mixing

(a) an acrylic resin composition comprising an acrylic resin (1) and an acrylic resin (2), and

(b) at least one selected from the group consisting of a hardener and a silane-based compound,

wherein the acrylic resin (1) comprises

(i) a repeating unit derived from a methacrylate of the formula (A) (repeating unit (i))

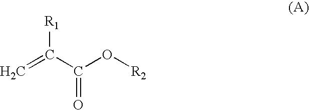

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds (repeating unit (ii)),

and wherein the acrylic resin (2) comprises repeating unit (i) and the acrylic resin (2) does not substantially have repeating unit (ii).

<9> The adhesive composition according to <8> wherein (b) at least one selected from the group consisting of a hardener and a silane-based compound is a hardener and the adhesive composition further comprises a hardening catalyst.

<10> An optical laminate film comprising

(I) an optical film and

(II) an adhesive composition layer obtained by mixing

(a) an acrylic resin composition comprising an acrylic resin (1) and an acrylic resin (2), and

(b) at least one selected from the group consisting of a hardener and a silane-based compound,

wherein the acrylic resin (1) comprises

(i) a repeating unit derived from a methacrylate of the formula (A) (repeating unit (i))

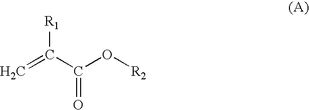

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds (repeating unit (ii)),

and wherein the acrylic resin (2) comprises repeating unit (i) and the acrylic resin (2) does not substantially have repeating unit (ii).

<11> The optical laminate film according to <10> wherein the optical film is at least one film selected from the group consisting of a polarizing film and phase retardation film.

<12> The optical laminate film according to <10> or <11> wherein the surface of the optical film is covered with acetylcellose based resin layer.

<13> The optical laminate film according to any of<10> to <12> wherein the surface of the adhesive composition layer is covered with release film.

<14> An optical laminate comprising

(X) an optical laminate film comprising

(I) an optical film and

(II) an adhesive composition layer obtained by mixing

(a) an acrylic resin composition comprising an acrylic resin (1) and an acrylic resin (2), and

(b) at least one selected from the group consisting of a hardener and a silane-based compound, and

(XX) a glass material layer,

wherein the glass material layer is on the surface of the adhesive composition layer of the optical laminate film,

wherein the acrylic resin (1) comprises

(i) a repeating unit derived from a methacrylate of the formula (A) (repeating unit (i))

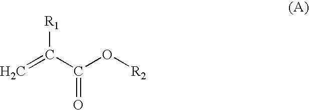

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds (repeating unit (ii)),

and wherein the acrylic resin (2) comprises repeating unit (i) and the acrylic resin (2) does not substantially have repeating unit (ii).

<15> The optical laminate according to <14> which is obtained by laminating the glass material layer on the surface of the adhesive composition layer of the optical laminate film after peeling off a release film from the optical laminate film of which the surface of the adhesive composition layer is covered with the release film.

### DETAILED DESCRIPTION OF PREFERRED EMBODIMENTS

The acrylic resin composition of the present invention (hereinafter referred to as “the present resin composition”) comprises an acrylic resin (1) and an acrylic resin (2).

The acrylic resin (1) comprises

(i) a repeating unit derived from a methacrylate of the formula (A)

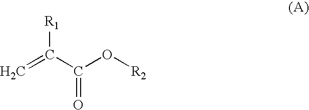

wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and

(ii) a repeating unit derived from a monomer having at least two olefinic double bonds.

The acrylic resin (1) can be obtained by copolymerizing the methacrylate of the formula (A) (hereinafter referred to as “monomer (a)”), a monomer having at least two olefinic double bonds (hereinafter referred to as “monomer (b)”), and optionally, other monomer.

The acrylic resin (2) comprises a repeating unit derived from a methacrylate of the formula (A) and it does not substantially have (ii) a repeating unit derived from a monomer having at least two olefinic double bonds.

The acrylic resin (2) can be obtained by polymerizing monomer (a) and optionally other monomer.

Examples of monomer (a) include acrylates such as methyl acrylate, ethyl acrylate, propyl acrylate, n-butyl acrylate, isobutyl acrylate, 2-ethylhexyl acrylate, n-octyl acrylate, isooctyl acrylate, lauryl acrylate, stearyl acrylate, cyclohexyl acrylate, benzyl acrylate, methoxyethyl acrylate, ethoxymethyl acrylate and the like; methacrylates such as methyl methacrylate, ethyl methacrylate, propyl methacrylate, n-butyl methacrylate, isobutyl methacrylate, 2-ethylhexyl methacrylate, n-octyl methacrylate, isooctyl methacrylate, lauryl methacrylate, stearyl methacrylate, cyclohexyl methacrylate, benzyl methacrylate, methoxyethyl methacrylate, ethoxymethyl methacrylate and the like.

In the acrylic resin (1), the content of a repeating unit derived from monomer (a) (hereinafter referred to as “repeating unit (i)”) is usually from about 65 to 99.85 parts by weight, preferably from about 73 to 95 parts by weight per 100 parts by weight of the acrylic resin (1).

In the acrylic resin (2), the content of repeating unit (i) is usually from 65 to 100 parts by weight per 100 parts by weight of acrylic resin (2).

Examples of monomer (b) include bi-functional monomers, tri-functional monomers, tetra-functional monomers, and the like. Specific examples bi-functional monomers include di(meth)acrylates such as 1,4-butanediol di(meth)acrylate, 1,6-hexanediol di(meth)acrylate, 1,9-nonanedilo di(meth)acrylate, ethylene glycol di(meth)acrylate, diethylene glycol di(meth)acrylate, tetraethylene glycol di(meth)acrylate, propylene glycol di(meth)acrylate, and the like; bis(meth)acrylamides such as methylenebis(meth)acrylamide, ethylenebis(meth)acrylamide and the like; divinyl esters such as divinyl adipate, divinyl sevacate and the like; allyl methacrylate; divinylbenzene; and the like. Specific examples of tri-functional monomers include tri-functional vinyl monomers such as 1,3,5-triacryloyl hexahydro-S-triazine, triallyl isocyanurate, triallylamine, N,N-diallylacrylamide and the like. Specific examples of tetra-functional monomers include tetra-functional vinyl monomers such as tetramethylolmethane tetraacrylate, tetraallyl pyromellitate, N,N,N′,N′-tetraallyl-1,4-diaminobutane, tetraallyl ammonium salt and the like.

As the monomer (b), different two or more monomers may be used.

Among monomers (b), monomers having in the molecule two (meth)acryloyl groups of the formula (B)

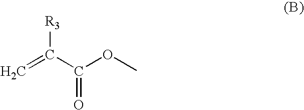

wherein, R₃ represents hydrogen or methyl, are preferred. Main chains composed of repeating unit (i) in the acrylic resin (1) are modified by a repeating unit derived from monomer (b).

In the acrylic resin (1), the content of a repeating unit derived from monomer (b) (hereinafter referred to as “repeating unit (ii)”) is usually from 0.05 to 5 parts by weight, preferably from 0.1 to 3 parts by weight per 100 parts by weight of acrylic resin (2). When the content of repeating unit (ii) is 0.05 part by weight or more, light leakages in optical laminates tend to be suppressed preferably, and when 5 parts by weight or less, productions of gel in producing the resin tend to be suppressed preferably.

The acrylic resin (2) substantially has no repeating unit (ii), in other word, the acrylic resin (2) is linear acrylic resin. In the present invention, “acrylic resin substantially having no repeating unit (ii)” means the acrylic resin in which the content of repeating unit (ii) satisfies the following formula.

[ii-2]/[ii-1]≦⅕

[ii-2]: the content of repeating unit (ii) in the acrylic resin (2)

[ii-1]: the content of repeating unit (ii) in the acrylic resin (1)

[ii-2]/[ii-1] is preferably less than 1/10.

In particular, the content of repeating unit (ii) in the acrylic resin (2) is preferably 0.02 part by weight or less, more preferably 0.01 part by weight or less per 100 parts by weight of the acrylic resin (2).

The acrylic resin (1) and the acrylic resin (2) preferably further comprise a repeating unit derived from a monomer containing at least one polar functional group selected from the group consisting of carboxyl, hydroxyl, amide, epoxy, formyl, oxetanyl, amino and isocyanate, and containing an olefinic double bond in the monomer (hereinafter the repeating unit is referred to as “repeating unit (iii)”, and the monomer is referred to as “monomer (c)”). The acrylic resin (2) particularly preferably comprises repeating unit (iii). When repeating unit (iii) exists in the acrylic resin (1) or the acrylic resin (2), light leakages in optical laminates tend to be suppressed.

Specific examples of the monomers having a carboxyl include acrylic acid, methacrylic acid, maleic acid, itaconic acid, maleic anhydride and the like, and examples of the monomers having a hydroxyl include 2-hydroxyethyl (meth)acrylate, 2-hydroxypropyl (meth)acrylate, 4-hydroxybutyl (meth)acrylate and the like. Examples of the monomers having an amide include acrylamide, methacrylamide, N-methylolacrylamide and the like, and examples of the monomers having an epoxy include glycidyl acrylate, glycidyl methacrylate and the like. Examples of the monomers having an oxetanyl include oxetanyl (meth)acrylate, 3-oxetanylmethyl (meth)acrylate, (3-methyl-3-oxetanyl)methyl (meth)acrylate, (3-ethyl-3-oxetanyl)methyl (meth)acrylate and the like, and examples of the monomers having an amino include N,N-dimethylaminoethyl acrylate, allylamine and the like. Examples of the monomers having an isocyanate include 2-methacryloyloxyethyl isocyanate and the like, and examples of the monomers having an formyl include acrylaldehyde and the like.

Among monomers (c), monomers having hydroxyl are suitable and 4-hydroxybutyl (meth)acrylate is particularly suitable.

As monomer (c), two or more of the monomers may be used.

The content of repeating unit (iii) in the acrylic resin (2) is usually from about 0.5 to 20 parts by weight, preferably from about 0.5 to 15 parts by weight per 100 parts by weight of the acrylic resin (2). When the content of repeating unit (iii) is 0.5 part by weight or more, the cohesive force of the resulting resin tends to increase preferably, and when 20 parts by weight or less, peeling between a glass material layer and an adhesive composition layer tends to be suppressed preferably in the use for the optical laminate mentioned later.

The content of repeating unit (iii) in the acrylic resin (1) is usually from about 0 to 20 parts by weight per 100 parts by weight of the acrylic resin (2). When the content of repeating unit (iii) is 20 parts by weight or less, peeling between a glass material layer and an adhesive composition layer tends to be suppressed preferably in the use for the optical laminate mentioned later.

In producing the acrylic resin (1) or the acrylic resin (2), it may also be copolymerized together with a vinyl-based monomer (hereinafter referred to as “monomer (d)”) in addition to monomer (a), monomers (a) and (b), monomers (a) and (c), or monomers (a), (b) and (c).

Examples of monomer (d) include vinyl esters of fatty acids, acrylates containing a dialkylamino group, (meth)acrylamides containing a dialkylamino group, vinyl halides, vinylidene halides, aromatic vinyls, (meth)acrylonitrile, conjugated diene compounds and the like.

Examples of the vinyl esters of fatty acids include vinyl acetate, vinyl propionate, vinyl butyrate, vinyl 2-ethylhexanoate, vinyl laurate and the like. Examples of the (meth)acrylate containing a dialkylamino group include dimethylaminoethyl (meth)acrylate, and the like, and examples of the (meth)acrylamide containing a dialkylamino group include dimethylaminopropyl (meth)acrylamide, and the like.

Examples of the vinyl halide include vinyl chloride, vinyl bromide, and the like, examples of the vinylidene halide include vinylidene chloride, and the like, and examples of the (meth)acrylonitrile include acrylonitrile, methacrylonitrile, and the like.

The conjugated diene compound is an olefin having in the molecule a conjugated double bond, and specific examples thereof include isoprene, butadiene, chloroprene, and the like.

The aromatic vinyl compound is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene, divinylbenzene and the like; nitrogen-containing aromatic vinyls such as vinylpyridine, vinylcarbazole, and the like.

The amount of monomer (d) contained in the acrylic resin (1) is usually 5 parts by weight or less, preferably 0.05 part by weight or less per 100 parts by weight of the acrylic resin (1), and more preferably, the acrylic resin (1) substantially contains no monomer (d).

The amount of monomer (d) contained in the acrylic resin (2) is usually 5 parts by weight or less, preferably 0.05 part by weight or less per 100 parts by weight of the acrylic resin (2), and more preferably the acrylic resin (2) substantially contains no monomer (d).

As the method of producing the acrylic resin (1) and the acrylic resin (2), there are listed, for example, a solution polymerization method, emulsion polymerization method, bulk polymerization method, suspension polymerization method, and the like.

In production of the acrylic resin (1) and the acrylic resin (2), a polymerization initiator is usually used. The polymerization initiator is used usually in an amount of about 0.001 to 5 parts by weight based on 100 parts by weight of the total weight of monomers used.

As the polymerization initiator, heat polymerization initiators and photo polymerization initiators are exemplified, and listed as the photo polymerization initiator are, for example, 4-(2-hydroxyethoxyphenyl) and the like. Examples of the heat polymerization initiators include azo-based compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methyl propionate), 4,4′-azobis(4-cyanovaleric acid), 2,2′-azobis(2-hydroxymethylpropionitrile), and the like; organic peroxides such as tert-butyl hydroperoxide, benzoyl peroxide, tert-butyl peroxybenzoate, cumene hydroperoxide, diisopropyl peroxydicarbonate, di-n-propyl peroxydicarbonate, tert-butyl peroxyneodecanoate, tert-butyl peroxypivalate, (3,5,5-trimethylhexanonyl) peroxide and the like; inorganic peroxides such as potassium persulfate, ammonium persulfate, hydrogen peroxide and the like.

Redox initiators using a heat polymerization initiator and a reducing agent can also be used as the polymerization initiator.

As the production method for the acrylic resin (1) and the acrylic resin (2), a solution polymerization method is preferable among others.

As the specific examples of the solution polymerization method, there are listed a method in which monomers used, and an organic solvent are mixed, and under a nitrogen atmosphere, a heat polymerization initiator is added to the mixture and the mixture is stirred from about 3 to 10 hours at about 40 to 90° C., preferably about 60 to 70° C., and the like. For controlling the reaction, monomers used and a heat polymerization initiator may be added during polymerization, or may be added in the form of solution in an organic solvent.

Examples of the organic solvent include aromatic hydrocarbons such as toluene, xylene, and the like; esters such as ethyl acetate, butyl acetate, and the like; aliphatic alcohols such as n-propyl alcohol, isopropyl alcohol, and the like; ketones such as methyl ethyl ketone, methyl isobutyl ketone, and the like.

Regarding the viscosity of thus obtained the acrylic resin (1), an ethyl acetate solution containing 30 wt % of the acrylic resin is prepared and the viscosity of this solution at 25° C. is usually 10 Pa.s or less, preferably 5 Pa.s or less. When the viscosity of the acrylic resin (1) is 10 Pa.s. or less, even if the dimension of an optical film changes, an adhesive composition layer obtained during this dimension change varies following the change in the use for the optical laminate film or the optical laminate mentioned later, consequently, there occurs a preferable tendency that a difference between brightness of circumferential parts of a liquid crystal cell and brightness of the center part disappears, and light leakage are suppressed in the use for the optical laminate.

Regarding the molecular weight of the acrylic resin (1), the weight-average molecular weight by a light scattering method according to gel permeation chromatography (GPC) is usually 5×10⁵ or more, preferably 1×10⁶ or more. When the weight-average molecular weight is 5×10⁵or more, there occurs a preferable tendency that adhesive property under high temperature and high humidity increases and peeling between a glass material layer and an adhesive composition layer decreases, further, there occurs a preferable tendency that a re-working property is improved in the use for the optical laminate film.

Regarding the molecular weight of the acrylic resin (2), the weight-average molecular weight by a light scattering method according to gel permeation chromatography (GPC) is usually 1×10⁶ or more, preferably from 2×10⁶ to 1×10⁷. When the weight-average molecular weight is 1×10⁶ or more, there preferably occurs a tendency that adhesive property under high temperature and high humidity increases and peeling between a glass material layer and an adhesive composition layer decreases, further, there preferably occurs a tendency that a re-working property is improved in the use for the optical laminate film. When the weight-average molecular weight is 1×10⁷ or less, even if the dimension of an optical film changes, an adhesive composition layer obtained during this dimension change varies following the change in the use for the optical laminate film mentioned later, consequently, there occurs a preferable tendency that a difference between brightness of circumferential parts of a liquid crystal cell and brightness of the center part disappears, and light leakage are suppressed in the use for the optical laminate.

The acrylic resin composition of the present invention comprises the acrylic resin (1) and the acrylic resin (2) (hereinafter referred to as “the present resin composition”). The present resin composition can usually be obtained by a method in which the acrylic resin (1) and the acrylic resin (2) are produced separately before mixing thereof. However, it can also be obtained by a method in which either the acrylic resin (1) or the acrylic resin (2) is produced, then, another acrylic resin is produced in the presence of the preliminarily produced acrylic resin.

The present resin composition may also be produced by a method in which the acrylic resin (1) and the acrylic resin (2) are mixed, then, the mixture is diluted with an organic solvent.

Regarding the weight ratio in the present resin composition, the content of the acrylic resin (1) is usually 5 parts by weight or more, preferably from 10 to 60 parts by weight per 100 parts by weight of the total amount of the acrylic resin (1) and the acrylic resin (2). When the content of the acrylic resin (1) is 5 parts by weight or more, even if the dimension of an optical film changes, an adhesive composition layer obtained during this dimension change varies following the change in the use for the optical laminate film mentioned later, consequently, there occurs a preferable tendency that a difference between brightness of circumferential parts of a liquid crystal cell and brightness of the center part disappears, and light leakage are suppressed in the use for the optical laminate.

The viscosity of an ethyl acetate solution of the present resin composition containing 30 wt % of non-volatile components at 25° C. is preferably 10 Pa.s or less, preferably from 1 to 5 Pa.s. When the viscosity is 10 Pa.s or less, there occurs preferably a tendency that adhesion under high temperature and high humidity increases and peeling between an optical film and the present composition layer is improved, further, there preferably occurs a tendency that a re-working property is improved.

The present resin composition may be used itself in, for example, an adhesive, paint, thickening agent and the like.

A composition obtained by mixing the present resin composition and at least one selected from the group consisting of a hardener and a silane-based compound is suitable as an adhesive (hereinafter referred to as “the present composition”).

The hardener has in the molecule two or more functional groups capable of cross-linking with a polar functional group, and specifically, isocyanate-based compounds, epoxy-based compounds, metal chelate-based compounds, aziridine-based compound and the like are exemplified.

Examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl-xylylene diisocyanate, naphthalene diisocyanate, triphenylmethane triisocyanate, polymethylene polyphenyl isocyanate and the like. Adducts obtained by reacting the above-mentioned isocyanate-based compound with a polyol such as trimethylolpropane and the like are also used as the hardener for the present composition.

Examples of the epoxy-based compound include a bisphenol A type epoxy resin, ethylene glycol glycidyl ether, polyethylene glycol diglycidyl ether, glycerine diglycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis(N,N′-diglycidylaminomethyl)cyclohexane, and the like.

Examples of the metal chelate compound include compounds obtained by coordinating a poly-valent metal such as aluminum, iron, copper, zinc, tin, titanium, nickel, antimony, magnesium, vanadium, chromium, zirconium and the like on acetylacetone or ethyl acetoacetate, and the like.

Examples of the aziridine-based compound include N,N′-diphenylmethane-4,4′-bis(1-aziridinecarboxide), N,N′-toluene-2,4-bis(1-aziridinecarboxamide), triethylenemelamine, bisisophthaloyl-1-(2-methylaziridine), tri-1-aziridinylphosphine oxide, N,N′-hexamethylene-1,6-bis(1-aziridinecarboxide), trimethylolpropane-tri-β-aziridinyl propionate, tetramethylolmethane-tri-β-aziridinyl propionate, and the like.

As the hardener in the present composition, two or more hardeners may be used.

The mixing amount of the hardener for obtaining the present composition is usually about 0.005 to 5 parts by weight, preferably about 0.01 to 3 parts by weight based on 100 parts by weight of the total non-volatile components in the present resin composition. When the amount of the hardener is 0.005 parts by weight or more, it is preferable that peeling between an optical film and the present composition layer tends to be suppressed and a re-working property tends to be improved, and when 5 parts by weight or less, it is preferable that light leakage tend to decrease since a property of the present composition layer of following dimension change of an optical film is excellent in the use of the optical laminate film or the optical laminate mentioned later.

As the silane-based compound used in the present composition, there are usually listed, for example, vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltriemthoxysilane, 3-aminopropyltriethoxysilane, 3-glycidoxypropyltrimethoxysilane, 3 -glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane and the like.

In the present composition, two or more silane-based compounds may be used.

The mixing amount of the silane-based compound for obtaining the present composition is usually about 0.0001 to 10 parts by weight, preferably 0.01 to 5 parts by weight based on 100 parts by weight of the total non-volatile components in the present resin composition. When the amount of the silane-based compound is 0.0001 part or more, it is preferable that close adherence between the present composition layer and a glass substrate is improved in the use of the optical laminate film or the optical laminate mentioned later. When the amount of the silane-based compound is 10 parts or less, it is preferable that bleeding out of the silane-based compound from the present composition layer tends to be suppressed and cohesive failure of the present composition layer also tends to be suppressed in the use of the optical laminate film or of the optical laminate.

The present composition can be obtained by mixing the present resin composition, a hardener and/or a silane-based compound, and an organic solvent used in the production of the present resin can be added, and further, a weather-resistant stabilizer, tackifier, plasticizer, softening agent, dye, pigment, inorganic filler, hardening catalyst, and the like can be added as long as the effect of the present invention is not prevented. When the present composition contains a hardener and a hardening catalyst, it is preferred that the present film mentioned later can be prepared in shorter aging period, and that the peeling between an optical film and the present composition layer and the foaming in the present composition layer in the use for the present laminate mentioned later tend to be suppressed, and re-working property of the present laminate is improved.

Examples of hardening catalyst include amine-based compound such as hexamethylenediamine, ethylenediamine, polyethyleneimine, hexamethylenetetramine, diethylenetriamine, triethylenetetramine, isophoronediamine, triethylenediamine, polyamino resins, melamine resins, and the like, when hardener is isocyanate-based compound.

The optical laminate film comprises (I) an optical film and (II) the present composition layer (hereinafter referred to as “the present film”).

The present film can be obtained, for example, by a method applying the present composition on a release film, evaporating an organic solvent by heating at usually from 60 to 120° C. for 0.5 to 10 minutes if the organic solvent is contained in the present composition layer, then pasting the present composition layer with an optical film, aging for 5 to 20 days at 23° C. and relative humidity of 50%; a method obtaining the present composition layer on the release film in the same manner as in the method above, piling the obtained laminates of the present composition layer and release film so as that each of the present composition layer and release film pile alternately, aging for 5 to 20 days at 23° C. and relative humidity of 50%, then, peeling out the top or bottom of release film, pasting the present composition layer with an optical film to obtain the present laminate film, taking out the present laminate film from next release film, repeating the series of operations until necessary number of the present laminate films are obtained; and the like.

The release film is a easy-peelable film used for producing the present composition layer, and usable for protecting films from dusts or other objects.

As the release film, there are listed, for example, those obtained by using as a base material a film made of various resins such as polyethylene terephthalate, polybutylene terephthalate, polycarbonate, polyarylate and the like and performing releasing treatment (silicone treatment and the like) on the joining plane of this base material with an adhesive layer, and the like.

The optical film used in the present film a film having an optical property, and for example, a polarizing film, phase retardation film and the like are listed.

The polarizing film is an optical film having a function of emitting polarization against incident light such as natural light and the like. Listed as the polarizing film are a linearly polarizing film having a property of absorbing linearly polarization of a plane of vibration parallel to an optical axis and allowing permeation of linearly polarization having a plane of vibration which is a vertical plane, a polarization separation film reflecting linearly polarization of a plane of vibration parallel to an optical axis, an elliptical polarizing film laminating a polarizing film with a phase retardation film described later, and the like.

Specific examples of the polarizing film include those in which a dichromatic coloring matter such as iodine, dichromatic dye and the like is adsorbed and oriented on a mono-axially stretched polyvinyl alcohol film, and the like.

The phase retardation film is a mono-axial or bi-axial optically anisotropic optical film, and examples thereof include stretched films obtained by stretching a polymer film made of polyvinyl alcohol, polycarbonate, polyester, polyarylate, polyimide, polyolefin, polystyrene, polysulfone, polyether sulfone, polyvinylidene fluoride/polymethyl methacrylate, liquid crystal polyester, acetylcellulose, cyclic polyolefin, ethylene-vinyl acetate copolymer-saponified substance, polyvinyl chloride or the like at a magnification of about 1.01 to 6, and the like. Among them, polymer films obtained by mono-axial stretching or bi-axial stretching of a polycarbonate or polyvinyl alcohol are preferable.

As the phase retardation film, there are listed a mono-axial phase retardation film, wide view range phase retardation film, low photoelasticity phase retardation film, temperature adjusting type phase retardation film, LC film (rod liquid crystal twisted orientation), WV film (disk liquid crystal inclined orientation), NH film (rod liquid crystal inclined orientation), VAC film (complete bi-axial orientation type phase retardation film), new VAC film (bi-axial orientation type phase retardation film), ad the like.

The present film may further comprises protective film (base film) on the surface of the optical film. The protective film is laminated on the opposite side to the present composition layer.

As the protective film, there are listed, for example, films made of acrylic resins different from the present resin, acetylcellulose-based films such as a cellulose triacetate film and the like, polyester resin films, olefin resin films, polycarbonate resin films, polyether ether ketone resin films, polysulfone resin films and the like. In the protective film, ultraviolet absorbers such as salicylate-based compounds, benzophenone-based compounds, benzotriazole-based compounds, triazine-based compounds, cyano acrylate-based compounds, nickel complex salt-based compounds and the like may also be contained. Among the protective films, acetylcellulose-based films are suitable.

The optical laminate of the present invention comprises the present film and a glass material layer (hereinafter referred to as “the present laminate”).

The present laminate can be obtained by laminating a glass material in the form of layer on the present composition layer of the present film. Here, as the glass material, there are listed, for example, liquid cell glass substrates, non-glaring glass, glass for sunglass and the like.

Among them, the present laminate comprising optical film(upper optical film), the present composition layer, upper glass substrate of liquid crystal cell, another optical film (lower optical film), the present composition layer and glass substrate of liquid crystal cell, which are laminated this order, is preferable since it can be used as a liquid display. The preferred embodiment can be obtained by laminating the present film (upper polarizing plate) on a upper glass substrate of a liquid crystal cell and laminating another present composition (lower polarizing plate) on a lower glass substrate of a liquid crystal cell.

Examples of the glass material include a soda lime glass, low alkali glass, non-alkali glass and the like.

When the present laminate film once laminated is peeled from a glass material layer of the present laminate, paste remaining and fogging on the surface of the glass substrate can be suppressed, which means that the present laminate is excellent in re-working property.

The present invention will be illustrated further specifically with examples. In the examples, “parts” and “%” are by weight unless otherwise stated. The measurement of non volatile content, which means the total content of non-volatile components, was carried out according to the method fixed by JIS K-5407. The viscosity is a value measured by a Brookfield viscometer at 25° C. For measurement of the weight-average molecule weight by a light scattering method of GPC, a GPC apparatus equipped with a light scattering photometer and a differential refractometer as a detector was used, and tetrahydrofuran was used as eluent, under conditions of a sample concentration of 5 mg/ml, a sample introduction amount of 100 μl, a column temperature of 40° C. and a flow rate of 1 ml/min. The weight-average molecular weight of any material used in the following examples was calculated by analyzing a material and a standard polystyrene by GPC in the same conditions, and then reducing the maintaining volume of the material to its molecular weight.

### ACRYLIC RESIN PRODUCTION EXAMPLE

### Polymerization Example 1

Into a reactor equipped with a cooling tube, nitrogen introduction tube, thermometer and stirrer was charged 233 parts of ethyl acetate, air in the apparatus was substituted with nitrogen gas, to produce no-oxygen-containing atmosphere, then, the inner temperature was raised to 70° C. 0.5 parts of azobisisobutyronitrile (hereinafter, referred to as “AIBN”) was added into the reactor, then, a mixed solution of 95 parts of butyl acrylate as monomer (a), 1 part of ethylene glycol diacrylate (hereinafter referred to as “EGDA”) as monomer (b) and 4 parts of 4-hydroxybutyl acrylate (hereinafter referred to as “4HBA”) as monomer (c) was dropped into the reaction system over a period of 3 hours while maintaining the inner temperature at 65-75° C. Thereafter, the temperature was maintained at 65-75° C. for 5 hours, to complete the reaction. The non-volatile content in the resulted acrylic resin solution was controlled to 30.0%, to find a viscosity of 263 mPa.s. The weight-average molecular weight by a light scattering method according to GPC is about 2,300,000, and the weight-average molecular weight reduced by polystyrene was 553,000.

### Polymerization Example 2

Acrylic resin was produced in the same manner as in Polymerization Example 1 except that monomer (b) was used in the amount shown in Table 1-1. The viscosity, and the weight-average molecular weight by a light scattering method and reduced by polystyrene of the resulted acrylic resin, are shown in Table 1-1.

### Polymerization Examples 3 to 4

Acrylic resins were produced in the same manner as in Polymerization Example 1 except that tripropylene glycol diacrylate (hereinafter referred to as “TPGDA”) was used as monomer (b) in the amount shown in Table 1-1, and acrylic acid was used as monomer (c) in the amount shown in Table 1-1. The viscosities, and the weight-average molecular weights by a light scattering method and reduced by polystyrene of the resulted acrylic resin, are shown in Table 1-1.

### Polymerization Example 5

Acrylic resin was produced in the same manner as in Polymerization Example 1 except that monomer (b) was not used. The viscosity, and the weight-average molecular weight by a light scattering method and reduced by polystyrene of the resulted acrylic resin, are shown in Table 1-2.

### Polymerization Example 6

Into the same reactor as in Polymerization Example 1 were charged 95 parts of butyl acrylate as monomer (a), 4 parts of 4HBA as monomer (c) and 233 parts of ethyl acetate, air in the apparatus was substituted with nitrogen gas, to produce no-oxygen-containing atmosphere, then, the inner temperature was raised to 70° C. 0.05 parts of AIBN was added, then, the temperature was maintained at 50° C. for 10 hours, to complete the reaction. The resulted reaction product was purified by precipitation with a methanol solvent, then, the solvent was distilled off, and dissolved again with ethyl acetate, obtaining an ethyl acetate solution of an acrylic resin having non-volatile content of 15%. The viscosity and the weight-average molecular weight of the resulted acrylic resin are shown in Table 1-2.

### Polymerization Example 7

The same reaction was conducted as in Polymerization Example 6 except that the reaction temperature was 60° C., to obtain an ethyl acetate solution of an acrylic resin having non-volatile content of 20.1%. The viscosity and the weight-average molecular weight of the resulted acrylic resin are shown in Table 1-2.

### Polymerization Example 8

Into the same reactor as in Polymerization Example 1 were charged 96 parts of ethyl acetate, 98 parts of butyl acrylate as monomer (a), 1.1 parts of 4HBA as monomer (c) and air in the apparatus was substituted with nitrogen gas, to produce no-oxygen-containing atmosphere, then, the inner temperature was raised to 55° C. A solution of 0.018 part of 2,2′-azobis(2,4-dimethylvaleronitrile) and 4 parts of ethyl acetate was added, then, the temperature was maintained at 54-56° C. for 3 hours. At that time, the calculated concentration of the ethyl acetate in the mixture was 50%. Then, ethyl acetate was added into the mixture to increase the concentration of ethyl acetate in the mixture by 5%, and the mixture was stirred for three hours at the same temperature above. The addition and the stirring were repeated until the calculated concentration of ethyl acetate in the mixture became 85%. After the final stirring, the resulted ethyl acetate solution of the acrylic resin having the concentration of 15.4% was obtained. The viscosity and the weight-average molecular weight of the resulted acrylic resin are shown in Table 1-2.

TABLE 1-1

| | | Polymerization Example | | | |
|---|---|---|---|---|---|
| | | 1 | 2 | 3 | 4 |
| Production | (a) Butyl acrylate | 95 | 95 | 98 | 99 |
| of acrylic | (b) EDGA | 1.0 | 0.5 | — | — |
| resin | TPGDA | — | — | 1.8 | 0.5 |
| (part) | (c) 4HBA | 4 | 4 | — | — |
| | Acrylic acid | — | — | 0.4 | 0.2 |
| | AIBN | 0.5 | 0.3 | 0.6 | 0.2 |
| Acrylic | Viscosity (mPa · s) | 263 | 390 | 291 | 427 |
| resin | Weight-average | 2.3 | 1.2 | 4.2 | 1.7 |
| | molecular weight/ | | | | |
| | light scattering | | | | |
| | (×1,000,000) | | | | |
| | Weight-average | 553 | 326 | 540 | 520 |
| | molecular weight/ | | | | |
| | reduced by polystyrene | | | | |
| | (×1000) | | | | |

TABLE 1-2

| | | Polymerization Example | | | |
|---|---|---|---|---|---|
| | | 5 | 6 | 7 | 8 |
| Production | (a) Butyl | 95 | 95 | 95 | 99 |
| | acrylate | | | | |
| of acrylic | (b) EDGA | — | — | — | — |
| resin | TPGDA | — | — | — | — |
| (part) | (c) 4HBA | 4 | 4 | 4 | — |
| | Acrylic acid | — | — | — | 1 |
| | AIBN | 0.6 | 0.05 | 0.05 | 0.05 |
| Acrylic | Viscosity | 46 | 51300 | 130000 | 271000 |
| | (mPa · s) | | | | |
| resin | Weight-average | 0.17 | 7.8 | 5.5 | 3.74 |
| | molecular | | | | |
| | weight/ | | | | |
| | light scattering | | | | |
| | (×1,000,000) | | | | |
| | Weight-average | 137 | 1860 | 1626 | 1350 |
| | molecular | | | | |
| | weight/ | | | | |
| | reduced by | | | | |
| | polystyrene | | | | |
| | (×1000) | | | | |

### Production Examples of Acrylic Resin Compositions and Adhesive Compositions

### Production Examples of Adhesive Compositions for Examples 1 to 6 and Comparative Examples 1 to 4

The acrylic resin (1) solution obtained in Polymerization Example (Polymerization Example 1, 2, or 5) and the acrylic resin (2) solution obtained in Polymerization Example (Polymerization Example 6 or 7) were mixed so that the non-volatile content in the acrylic resin (1) and the non-volatile content in the acrylic resin (2) became to the amounts described in Table 2-1 to obtain ethyl acetate solution of the acrylic resin composition. The viscosity of each acrylic resin composition shown in Table 2-1 is the value measured at the concentration of non-volatile content of 30%.

Isocyanate based compound (Trade name: Colonate L, made by Nippon Polyurethane Industry Co., Ltd.) as a hardener and y-glycidoxypropyltrimethoxysilane as a silane type compound were mixed with the ethyl acetate solution of acrylic resin composition obtained in which the amount of the isocyanate based compound reduced to the content of active ingredient is 0.1 part and the amount of γ-glycidoxypropyltrimethoxysilane reduced to the content of active ingredient is 0.2 part per 100 parts of total non-volatile components in the ethyl acetate solution of acrylic resin composition.

### Production Examples of Adhesive Compositions for Examples 7 to 10 and Comparative Example 5

The acrylic resin (1) solution obtained in Polymerization Example (Polymerization Example 3 or 4) and the acrylic resin (2) solution obtained in Polymerization Example (Polymerization Example 8) were mixed so that the non-volatile content in the acrylic resin (1) and the non-volatile content in the acrylic resin (2) were the amounts described in Table 3-1 to obtain ethyl acetate solution of the acrylic resin composition.

Isocyanate-based compound (Trade name: Colonate L, made by Nippon Polyurethane Industry Co., Ltd.) as a hardener, γ-glycidoxypropyltrimethoxysilane as a silane type compound and triethylenediamine as an organic amine compound were mixed with the ethyl acetate solution of acrylic resin composition obtained in which the amount of the isocyanate based compound reduced to non-volatile content is 0.1 part, the amount of y-glycidoxypropyltrimethoxysilane reduced to non-volatile content is 0.2 part and an amount described in Table 3-1 of triethylenediamine per 100 parts of non-volatile content in the ethyl acetate solution of acrylic resin composition.

### Examples 1 to 5 and Comparative Examples 1 to 4

### Production Examples of Optical Laminate

Thus, obtained adhesive was applied on a polyethylene terephthalate release film (manufactured by Linteck Corporation, trade name: PET 3811), then, dried. In this operation, the adhesive layer after drying was controlled to have a thickness of 25 μm. Then, a polarizing film of 180 μm (a three-layer film obtained by placing a triacetylcellulose-based protective film on both surfaces of a film prepared by allowing polyvinyl alcohol to adsorb iodine and stretching this) was used as an optical film, and on this optical film, the adhesive layer was laminated from the resulted release film by a laminator, then, the laminate was aged for 14 days under conditions of a temperature of 40° C. and a humidity of 50% RH, to obtain an optical film with adhesive.

The adhesive layer of the optical film with adhesive obtained above was laminated on both surfaces of a glass substrate for liquid crystal cell (manufactured by Nippon Sheet Glass Co., Ltd., soda lime glass) so as to give crossed Nicols, obtaining an optical laminate. This was stored at 80° C. for 96 hours in dry condition (condition 1) or stored at 60° C. and 90% RH for 96 hours (condition 2). Then, conditions of durability and manifestation of light leakage of the optical laminate after respective storages were visually observed. The results are classified as described below and summarized in Table 2-2.

<Light Leakage Manifestation Condition>

The condition of manifestation of light leakage was evaluated based on the following 4 stages.

⊚: Light leakage is not observed at all.

◯: Light leakage is scarcely noticeable.

Δ: Light leakage is somewhat noticeable.

×: Light leakage is remarkably recognized.

<Durability>

Evaluation of durability was conducted based on the following 4 stages.

⊚: Changes in appearances such as float, peeling, foaming and the like are not observed at all.

◯: Changes in appearances such as float, peeling, foaming and the like are scarcely observed.

Δ: Changes in appearances such as float, peeling, foaming and the like are somewhat noticeable.

×: Changes in appearances such as float, peeling, foaming and the like are remarkably recognized.

<Re-Working Property>

Evaluation of a re-working property was conducted as follows.

First, the above-mentioned optical film with adhesive was cut into specimens of 25 mm×150 mm. Next, this specimen was laminated on a glass substrate for liquid crystal cell (manufactured by Nippon Sheet Glass Co., Ltd., soda lime glass) using a pasting apparatus (manufactured by Fuji Plastic Machine K.K., Lamipacker), and the laminate was subjected to autoclave treatment at 50° C. and 5 kg/cm² (490.3 kPa) for 20 minutes, to obtain an optical laminate for peeling test. Subsequently, this optical laminate for peeling test was heated at 70° C. for 2 hours, and then, stored in an oven at 50° C. for 48 hours. After the storing, this pasted specimen was peeled toward 180° direction at a speed of 300 mm/min in an atmosphere of 23° C. and 50% RH, and the condition of the surface of the resulted glass plate was observed. The results are classified as described below and summarized in Tables 2 and 3.

Evaluation of a re-working property was conducted based on the following 4 stages depending on the condition of the surface of a glass plate.

⊚: Fogging and paste remaining are not observed at all on the surface of a glass plate.

◯: Fogging and the like are scarcely observed but paste remaining is not observed on the surface of a glass plate.

Δ: Fogging and the like are observed but paste remaining is not observed on the surface of a glass plate.

×: Paste remaining is observed on the surface of a glass plate.

TABLE 2-1

| | Acrylic | | Acrylic | | Acrylic resin | |
|---|---|---|---|---|---|---|
| | resin (1) | | resin (2) | | composition | |
| | | WNVC^{*1} | Poly. | WNVC^{*1} | Visc.^{*2} | |
| | Poly. Ex. | (parts) | Ex. | (parts) | (mPa · s) | iiR2/1^{*3} |
| Ex. 1 | 1 | 90 | 6 | 10 | 263 | 0 |
| Ex. 2 | 1 | 80 | 6 | 20 | 910 | 0 |
| Ex. 3 | 1 | 70 | 6 | 30 | 2720 | 0 |
| Ex. 4 | 1 | 70 | 7 | 30 | 6700 | 0 |
| Ex. 5 | 2 | 80 | 6 | 20 | 513000 | 0 |
| Comp. | 1 | 100 | — | 0 | 2900 | 0 |
| Ex. 1 | | | | | | |
| Comp. | — | 0 | 6 | 100 | 2350 | 0 |
| Ex. 2 | | | | | | |
| Comp. | 5 | 80 | 6 | 20 | 1540 | *4 |
| Ex. 3 | | | | | | |
| Comp. | 5 | 80 | 7 | 20 | 640 | *4 |
| Ex. 4 | | | | | | |

WNVC^{*1}: Weight of Non-volatile content
Visc.^{*2}: Viscosity of ethyl acetate solution having a non-volatile content of 30% at 25° C.
iiR2/1^{*3}: [ii-2]/[ii-1]
[ii-2]: the content of repeating unit (ii) in the acrylic resin (2)
[ii-1]: the content of repeating unit (ii) in the acrylic resin (1)
*4: None of Acrylic resins (1) and (2) contains a repeating unit (ii).

TABLE 2-2

| | Condition 1^{*6} | | Condition 2^{*6} | | |
|---|---|---|---|---|---|
| | Dura.^{*7} | LLMC^{*8} | Dura.^{*7} | LLMC^{*8} | RWP^{*9} |
| Ex. 1 | ⊚ | ⊚ | ◯ | ⊚ | ◯ |
| Ex. 2 | ⊚ | ⊚ | ⊚ | ⊚ | ⊚ |
| Ex. 3 | ⊚ | ◯ | ⊚ | ⊚ | ⊚ |
| Ex. 4 | ⊚ | ⊚ | ⊚ | ⊚ | ⊚ |
| Ex. 5 | ⊚ | ⊚ | ⊚ | ⊚ | ⊚ |
| Comp. Ex. 1 | ◯ | ⊚ | Δ | ⊚ | X |
| Comp. Ex. 2 | ⊚ | X | ⊚ | X | ⊚ |
| Comp. Ex. 3 | Δ | ⊚ | X | ⊚ | ◯ |
| Comp. Ex. 4 | X | ⊚ | X | ⊚ | ◯ |

Condition 1^{*6} or Condition 2^{*6}: Optical film with adhesive was aged for 14 days under conditions of a temperature of 40° C. and a humidity of 50% RH.
Dura.^{*7}: Durability
LLMC^{*8}: Light Leakage Manifestation Condition
RWP^{*9}: Re-Working Property

### Examples 7 to 10 and Comparative Examples 5

### Production Examples of Optical Laminate

Optical laminate was produced and evaluated in the same manner as in Example 1 except that aging period of optical film with adhesive obtained was 7 days. The results are shown in Table 3-2.

TABLE 3-1

| | | | | | Acrylic resin | | |
|---|---|---|---|---|---|---|---|
| | Acrylic resin (1) | | Acrylic resin (2) | | composition | | TEDA^{*5} |
| | | WNVC^{*1} | | WNVC^{*1} | Visc.^{*2} | | WNVC^{*1} |
| | Poly. Ex. | (parts) | Poly. Ex. | (parts) | (mPa · s) | iiR2/1^{*3} | (parts) |
| Ex. 6 | 3 | 40 | 8 | 60 | 25400 | 0 | 0.0065 |
| Ex. 7 | 3 | 40 | 8 | 60 | 25400 | 0 | 0.0100 |
| Ex. 8 | 4 | 40 | 8 | 60 | 25700 | 0 | 0.0065 |
| Ex. 9 | 4 | 40 | 8 | 60 | 25700 | 0 | 0.0100 |
| Comp. Ex. 5 | — | — | 8 | 100 | — | *4 | — |

WNVC^{*1}: Weight of Non-volatile content
Visc.^{*2}: Viscosity of ethyl acetate solution having a non-volatile content of 30% at 25° C.
iiR2/1^{*3}: [ii-2]/[ii-1]
[ii-2]: the content of repeating unit (ii) in the acrylic resin (2)
[ii-1]: the content of repeating unit (ii) in the acrylic resin (1)
*4: None of Acrylic resins (1) and (2) contains a repeating unit (ii).
TEDA^{*5}: Triethylenediamine

TABLE 3-2

| | Condition 1^{*6} | | Condition 2^{*6} | | |
|---|---|---|---|---|---|
| | Dura.^{*7} | LLMC^{*8} | Dura.^{*7} | LLMC^{*8} | RWP^{*9} |
| Ex. 6 | ⊚ | ◯ | ⊚ | ◯ | ◯ |
| Ex. 7 | ⊚ | ◯ | ⊚ | ◯ | ◯ |
| Ex. 8 | ⊚ | ⊚ | ⊚ | ⊚ | ◯ |
| Ex. 9 | ⊚ | ⊚ | ⊚ | ⊚ | ◯ |
| Comp. Ex. 5 | ⊚ | X | ⊚ | X | ⊚ |

Condition 1^{*6} or Condition 2^{*6}: Optical film with adhesive was aged for 7 days under conditions of a temperature of 40° C. and a humidity of 50% RH.
Dura.^{*7}: Durability
LLMC^{*8}: Light Leakage Manifestation Condition
RWP^{*9}: Re-Working Property

The acrylic resin composition of the present invention can suitably be used for, for example, adhesives, paints, thickening agents and the like. The adhesive composition of the present invention can suitably be used as an adhesive for, for example, optical laminates such as liquid crystal cells.

What is claimed is:

1. An acrylic resin composition comprising an acrylic resin (1) and an acrylic resin (2),
wherein the acrylic resin (1) comprises
(i) a repeating unit derived from a methacrylate of the formula (A) (repeating unit (i)) 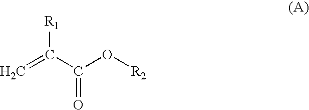
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and
(ii) a repeating unit derived from a monomer having at least two olefinic double bonds (repeating unit (ii)),
and wherein the acrylic resin (2) comprises repeating unit (i) and the acrylic resin (2) does not substantially have repeating unit (ii).

2. The acrylic resin composition according to claim 1 wherein the content ratio of repeating unit (ii) in the acrylic resin (2) to repeating unit (ii) in the acrylic resin (1) is less than 1/10.

3. The acrylic resin composition according to claim 1 wherein the content of repeating unit (i) in the acrylic resin (1) is 65 to 99.85 parts by weight per 100 parts by weight of the acrylic resin (1).

4. The acrylic resin composition according to claim 1 wherein the content of repeating unit (ii) in the acrylic resin (1) is 0.05 to 5 parts by weight per 100 parts by weight of the acrylic resin (1).

5. The acrylic resin composition according to claim 1 wherein at least one acrylic resin selected from the group consisting of the acrylic resin (1) and the acrylic resin (2) further comprises (iii) a repeating unit derived from a monomer containing at least one polar functional group selected from the group consisting of carboxyl, hydroxyl, amide, epoxy, formyl, oxetany, amino and isocyanate, and containing an olefinic double bond.

6. The acrylic resin composition according to claim 1 wherein repeating unit (ii) is a repeating unit derived from a monomer comprising at least two (meth)acryloyl groups of the formula (B) 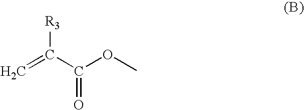
wherein R₃ represents hydrogen or methyl.

7. The acrylic resin composition according to claim 1 wherein the content of the acrylic resin (1) is 10 to 60 parts by weight per 100 parts by weight of total the acrylic resin (1) and the acrylic resin (2).

8. An adhesive composition obtained by mixing
(a) an acrylic resin composition comprising an acrylic resin (1) and an acrylic resin (2), and
(b) at least one selected from the group consisting of a hardener and a silane-based compound,
wherein the acrylic resin (1) comprises
(i) a repeating unit derived from a methacrylate of the formula (A) (repeating unit (i)) 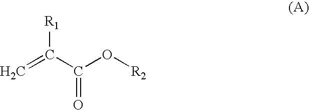
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and
(ii) a repeating unit derived from a monomer having at least two olefinic double bonds (repeating unit (ii)),
and wherein the acrylic resin (2) comprises repeating unit (i) and the acrylic resin (2) does not substantially have repeating unit (ii).

9. The adhesive composition according to claim 8 wherein (b) at least one selected from the group consisting of a hardener and a silane-based compound is a hardener and the adhesive composition further comprises a hardening catalyst.

10. An optical laminate film comprising
(I) an optical film and
(II) an adhesive composition layer obtained by mixing
(a) an acrylic resin composition comprising an acrylic resin (1) and an acrylic resin (2), and
(b) at least one selected from the group consisting of a hardener and a silane-based compound,
wherein the acrylic resin (1) comprises
(i) a repeating unit derived from a methacrylate of the formula (A) (repeating unit (i)) 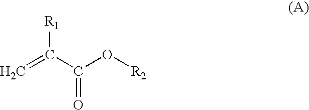
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and
(ii) a repeating unit derived from a monomer having at least two olefinic double bonds (repeating unit (ii)),
and wherein the acrylic resin (2) comprises repeating unit (i) and the acrylic resin (2) does not substantially have repeating unit (ii).

11. The optical laminate film according to claim 10 wherein the optical film is at least one film selected from the group consisting of a polarizing film and phase retardation film.

12. The optical laminate film according to claim 10 wherein the surface of the optical film is covered with acetylcellose based resin layer.

13. The optical laminate film according to claim 10 wherein the surface of the adhesive composition layer is covered with release film.

14. An optical laminate comprising
(X) an optical laminate film comprising
(I) an optical film and
(II) an adhesive composition layer obtained by mixing
(a) an acrylic resin composition comprising an acrylic resin (1) and an acrylic resin (2), and
(b) at least one selected from the group consisting of a hardener and a silane-based compound, and
(XX) a glass material layer,
wherein the glass material layer is on the surface of the adhesive composition layer of the optical laminate film,
wherein the acrylic resin (1) comprises
(i) a repeating unit derived from a methacrylate of the formula (A) (repeating unit (i)) 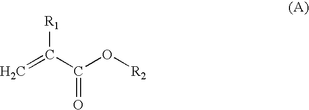
wherein R₁ represents hydrogen or methyl, R₂ represents alkyl having 1 to 14 carbon atoms or aralkyl having 7 to 14 carbon atoms, and at least one hydrogen in the alkyl or aralkyl may be substituted with alkoxy having 1 to 10 carbon atoms, and
(ii) a repeating unit derived from a monomer having at least two olefinic double bonds (repeating unit (ii)),
and wherein the acrylic resin (2) comprises repeating unit (i) and the acrylic resin (2) does not substantially have repeating unit (ii).

15. The optical laminate according to claim 14 which is obtained by laminating the glass material layer on the surface of the adhesive composition layer of the optical laminate film after peeling off a release film from the optical laminate film of which the surface of the adhesive composition layer is covered with the release film.
